(19) United States
(12) Patent Application Publication
(10) Pub. No.: US 2002/0038797 A1
(43) Pub. Date: Apr. 4, 2002

(54) ARRANGEMENT FOR HEATING AN ASSEMBLED PRINTED CIRCUIT BOARD

(76) Inventors: CARSTEN FRIEDRICH, LUDWIGSBURG (DE); NORBERT JEGGLE, MARBACH (DE)

Correspondence Address: SUGHRUE MION ZINN MACPEAK & SEAS PLLC, 2100 PENNSYLVANIA AVENUE N W, WASHINGTON, DC, 200373213

(21) Appl. No.: 09/433,723

(22) Filed: Nov. 4, 1999

(30) Foreign Application Priority Data
Nov. 6, 1998 (DE) 198 51 172.8

(51) Int. Cl. H05B 3/16; H05B 1/00

(52) U.S. Cl. 219/209; 219/210; 219/543

(57) ABSTRACT

The invention relates to an arrangement for heating an assembled printed circuit board to a specified temperature. A plurality of resistors are arranged on at least one surface of the printed circuit board in order to generate heat. The resistors are distributed approximately uniformly over the surface and are supplied with electronic energy from a separate source.

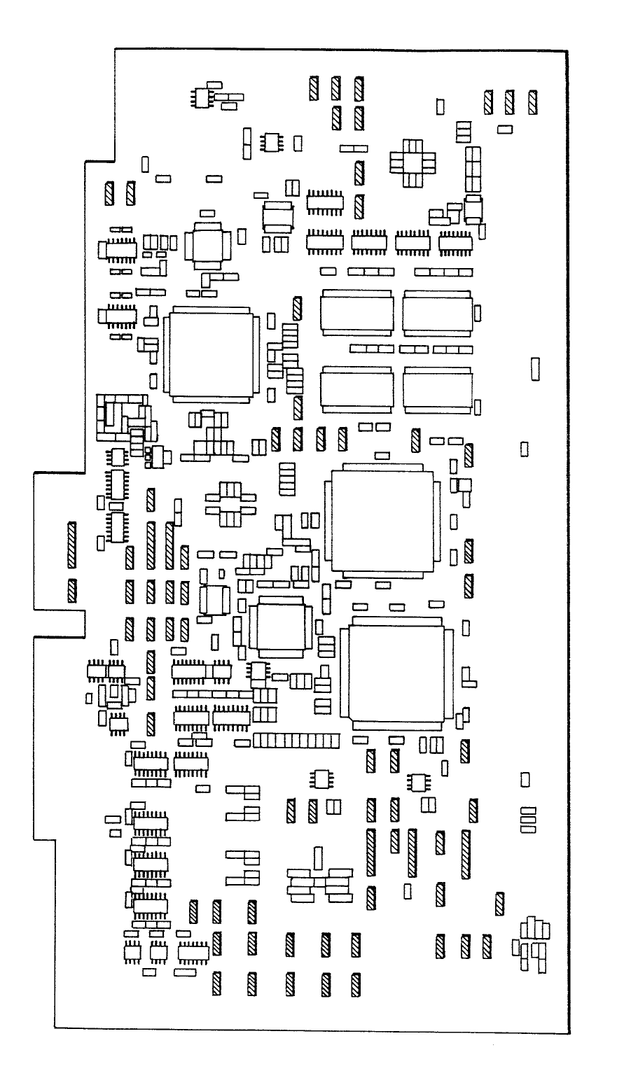

The invention relates to an arrangement for heating an assembled printed circuit board to a specified temperature. Electronic circuits exist which need to be operated at an optimal temperature. In the case of these electronic circuits the temperature must therefore be increased when necessary to the optimal temperature and the optimal temperature must be maintained.

One possibility of heating the electronic circuit consists in encasing it entirely or partially with a heating foil. However, this has the disadvantage that other, for example mechanical, parts such as housing, screws and the like are also heated. This is undesirable and leads to an increased outlay.

The technical problem on which the invention is based thus consists in providing a method whereby only those parts of the electronic circuit which are to possess the required temperature are heated.

This technical problem is solved, in accordance with the invention, in that a plurality of resistors are arranged on at least one surface of the printed circuit board. Claims 2 and 3 contain advantageous details of the invention, which is explained in the following in the form of an exemplary embodiment illustrated in the FIGURE.

The FIGURE represents a plan view of a surface of a printed circuit board, for example a so-called multilayer printed circuit board, equipped with a number of components, such as integrated circuits, multichip modules. In addition to the resistors, capacitors and the like required for the operation of the electronic circuit, the printed circuit board is also equipped with a plurality of resistors, for example chip resistors, shaded in black in the FIGURE. These resistors are distributed more or less uniformly over the surface.

In the illustrated exemplary embodiment a total of 150 resistors with a value of 3.01 KΩ were provided on both surfaces of the printed circuit board. The resistors are supplied with electric energy on two separate conductor path levels in a multilayer arrangement. In this exemplary embodiment approximately 30 W heat was generated and the heat was uniformly distributed.

1. An arrangement for heating an assembled printed circuit board to a specified temperature, characterised in that a plurality of resistors are arranged on at least one surface of the printed circuit board.

2. An arrangement according to claim 1, characterised in that the voltage supply to the resistors takes place from a separate voltage source.

3. An arrangement according to claims 1 and 2, characterised in that the voltage supply to the resistors is provided with a regulating means.
